(19) United States
(12) Patent Application Publication
(10) Pub. No.: US 2007/0152146 A1
(43) Pub. Date: Jul. 5, 2007

(54) Assembling structure for a solid image pickup device

(75) Inventor: Min-Che Li, Taichung City (TW)

Correspondence Address: CHARLES E. BAXLEY, ESQ., 90 JOHN STREET, THIRD FLOOR, NEW YORK, NY, 10038, US

(73) Assignee: Largan Precision Co., Ltd.

(21) Appl. No.: 11/324,688

(22) Filed: Jan. 3, 2006

(51) Int. Cl. H01J 40/14; H01J 5/02

(52) U.S. Cl. 250/239

(57) ABSTRACT

An assembling structure for a solid image pickup device in accordance with the present invention is mounted on a substrate and comprises a mounting base, a lens tube and an adhesive material. The adhesive material is arranged on the bottom surface of an engaging recess of the mounting base. When an annular engaging portion of the lens tube is screwed in the engaging recess of the mounting base, the adhesive material is located beside the inner periphery of the annular engaging portion of the lens tube, so that powder produced when screwing the lens tube relative to the mounting base will be adhered to the adhesive material, thus preventing the powder from falling onto the protective piece.

### BACKGROUND OF THE INVENTION

1. Field of the Invention

The present invention relates to an image pickup device, and more particularly to an assembling structure for an image pickup device.

2. Description of the Prior Art

Referring to FIG. 1, which shows a solid image pickup device disclosed by JP Pt No. 2005-51524, when adjusting the screw distance (that is adjusting the image focal length of the lens array 13 inside the lens tube 11, so as to enable the optical signal of the object to be focused on the image sensor 15) between the lens tube 11 and the mounting base 12, powder A will be produced by the screwing friction between the lens tube 11 and the mounting base 12. And JP Pt No. 2005-51524 is aimed at preventing the powder A from falling onto the protective glass 14 inside the mounting base 12, so that, during shooting, the image of the object to be shot will pass through the lens array 13 and the protective glass 14 and then will be projected on the image sensor 15 of the mounting base 12 precisely without being blocked by the powder A, and preventing the occurrence of fogging or halation on the image sensor 15 of the substrate 16.

In fact, between the lens tube 11 and the mounting base 12 is further disposed an elastic washer 17 for blocking off the powder A and preventing it from falling onto the protective glass 14.

The solid image pickup device shall be minimized in size since it is normally installed on the cell phone, PDA and etc. Assembling such small component (the elastic washer 17) is inconvenient and troublesome, therefore, the conventional structure for preventing the powder A from falling onto the protective glass 14 is not easy to be assembled.

The present invention has arisen to mitigate and/or obviate the afore-described disadvantages.

### SUMMARY OF THE INVENTION

The primary objective of the present invention is to provide an assembling structure for a solid image pickup device, wherein the powder produced when the user screws the lens tube relative to the mounting base will be stuck on the adhesive material, thus preventing the powder from falling onto the protective piece.

The assembling structure for a solid image pickup device in accordance with the present invention is mounted on a substrate and comprises a mounting base, a lens tube and an adhesive material. The adhesive material is arranged on the bottom surface of an engaging recess of the mounting base. When an annular engaging portion of the lens tube is screwed in the engaging recess of the mounting base, the adhesive material is located beside the inner periphery of the annular engaging portion of the lens tube, so that powder produced when screwing the lens tube relative to the mounting base will be adhered to the adhesive material.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional assembly view of a conventional solid image pickup device;

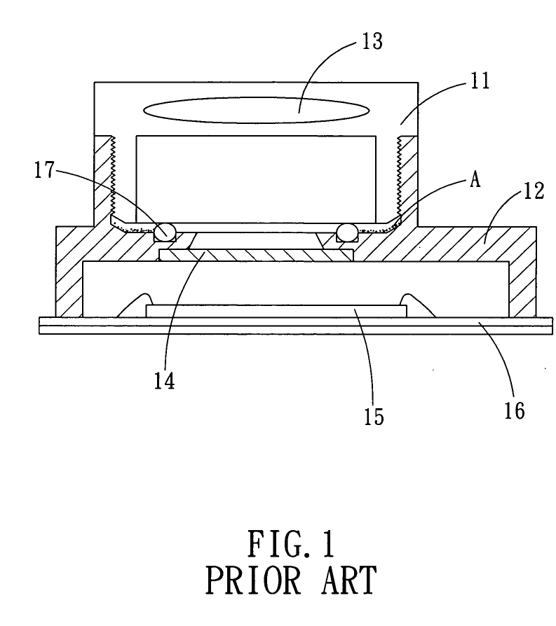

FIG. 2 is an exploded view of an assembling structure for a solid image pickup device in accordance with a first embodiment of the present invention;

FIG. 3 is a cross sectional view of the assembling structure for a solid image pickup device in accordance with the first embodiment of the present invention;

FIG. 4 is an exploded view of an assembling structure for a solid image pickup device in accordance with a second embodiment of the present invention;

FIG. 5 is a cross sectional view of the assembling structure for a solid image pickup device in accordance with the second embodiment of the present invention;

FIG. 6 is a cross sectional view of the assembling structure for a solid image pickup device in accordance with a third embodiment of the present invention; and

FIG. 7 is a cross sectional view of the assembling structure for a solid image pickup device in accordance with a fourth embodiment of the present invention.

### DETAILED DESCRIPTION OF THE PREFERRED EMBODIMENTS

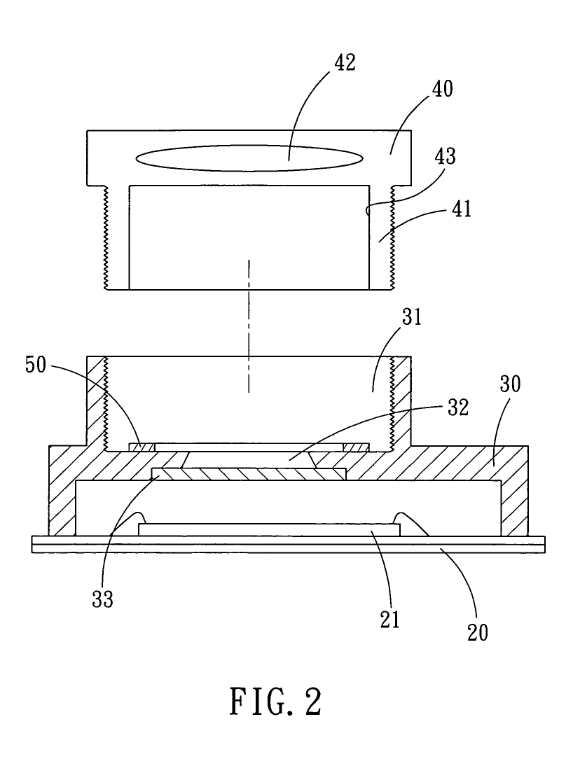

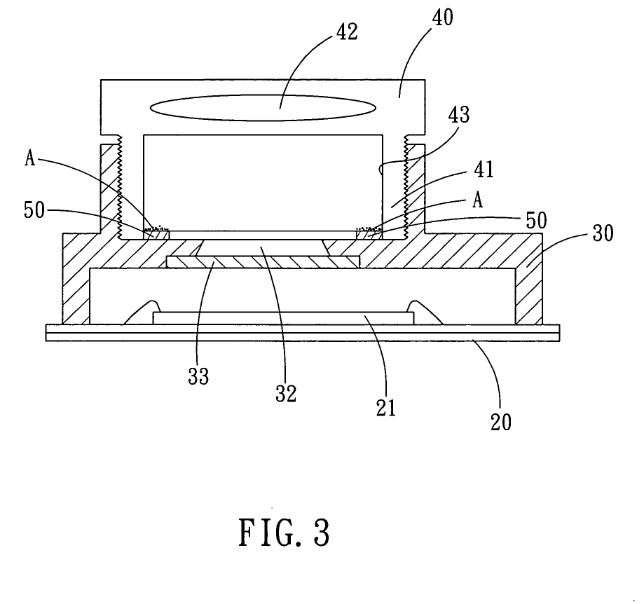

Referring to FIGS. 2 and 3, a solid image pickup device in accordance with a first embodiment of the present invention is mounted on a substrate 20 and comprises a mounting base 30, a lens tube 40 and an adhesive material 50.

The substrate 20 is equipped with an image sensor 21.

The mounting base 30 is mounted on the substrate 20 and located over the image sensor 21. The mounting base 30 is defined with an engaging recess 31, and on the inner periphery of the engaging recess 31 is formed a thread structure. A light passage 32 is defined in the bottom of the engaging recess 31, and in the light passage 32 is disposed a protective piece 33.

The lens tube 40 has an annular engaging portion 41 and on the outer periphery of the annular engaging portion 41 is formed a thread structure. The annular engaging portion 41 of the lens tube 40 is to be screwed in the engaging recess 31 of the mounting base 30, and in the lens tube 40 is disposed a lens array 42.

The adhesive material 50 includes glue or double stick tape, and is arranged on the bottom surface of the engaging recess 31 of the mounting base 30 and located beside the inner periphery 43 of the annular engaging portion 41 of the lens tube 40.

For a better understanding of the first embodiment, its operation and function, reference should be made to FIG. 3 in conjunction with the following descriptions.

When the user screws the lens tube 40 relative to the mounting base 30, namely adjusting the imaging focal length of the lens array 42 inside the lens tube 40 in order to enable the optical signal of the object to be focused on the image sensor 21. The annular engaging portion 41 of the lens tube 40 is screwed in the engaging recess 31 of the mounting base 30, the powder A produced during screwing the lens tube. 40 relative to the mounting base 30 will be adhered to the adhesive material, and thus preventing the powder A falling onto the protective piece.

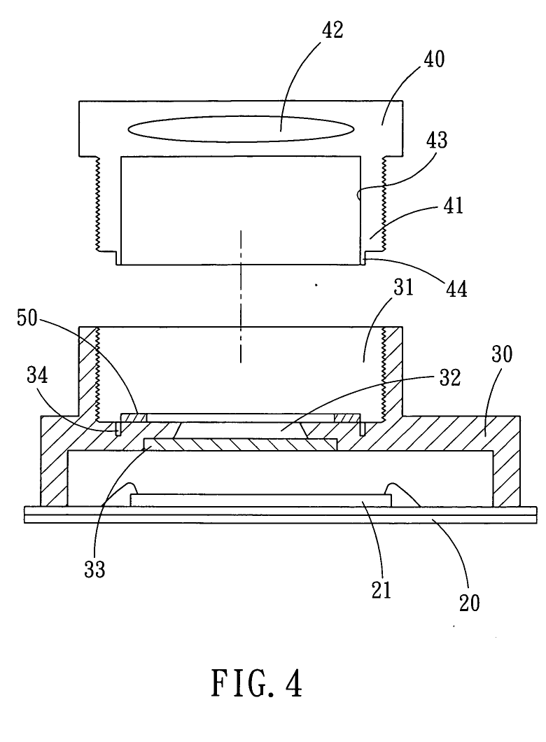

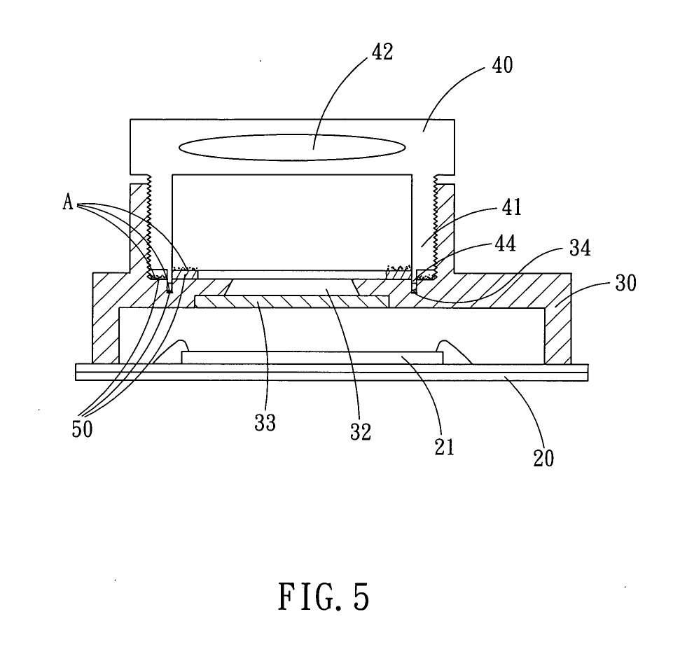

Referring then to FIGS. 4 and 5, a second embodiment of the present invention is illustrated, which is similar to the first embodiment, except that: an annular groove 34 is formed in the bottom surface of the engaging recess 31 and located around the light passage 32. On the terminal end of the annular engaging portion 41 of the lens tube 40 is formed an annular flange 44 that is located close to the inner periphery of the lens tube 40. When the annular engaging portion 41 of the lens tube 40 is screwed in the engaging recess 31 of the mounting base 30, the annular flange 44 will be engaged in the annular groove 34. The adhesive material 50 is arranged in the annular groove 34, and a part of the bottom surface of the engaging recess 31 of the mounting base 30 for mating with the annular engaging portion 41 of the lens tube 40 is attached with the adhesive material 50.

The annular engaging portion 41 of the lens tube 40 is screwed in the engaging recess 31 of the mounting base 30, and the annular flange 44 is engaged in the annular groove 34, so that the powder A produced during the process of screwing the lens tube 40 relative to the mounting base 30 will be blocked by the annular flange 42 of the lens tube 40 or will fall into the annular groove 34 of the mounting base 30, or into the space defined by the annular flange 44 of the lens tube 40 and the mounting base 30. Furthermore, the adhesive material 50 also can be used to stick the powder A. Therefore the abovementioned arrangement can produce a better effect on prevention of the powder A.

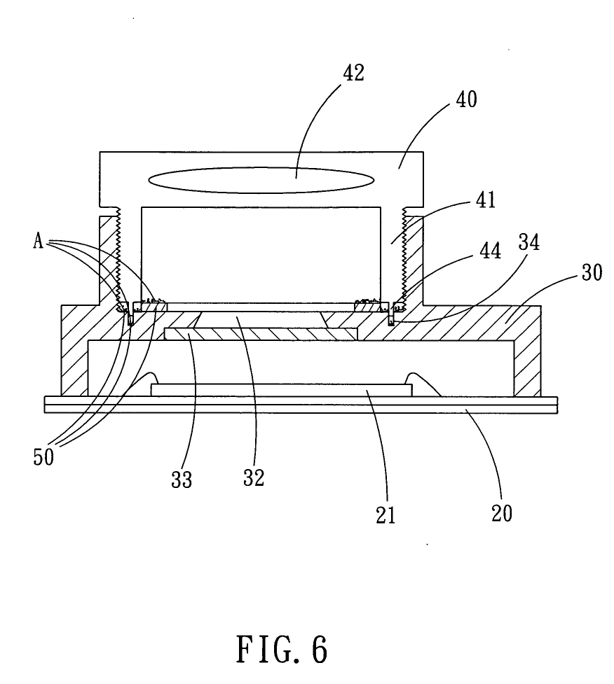

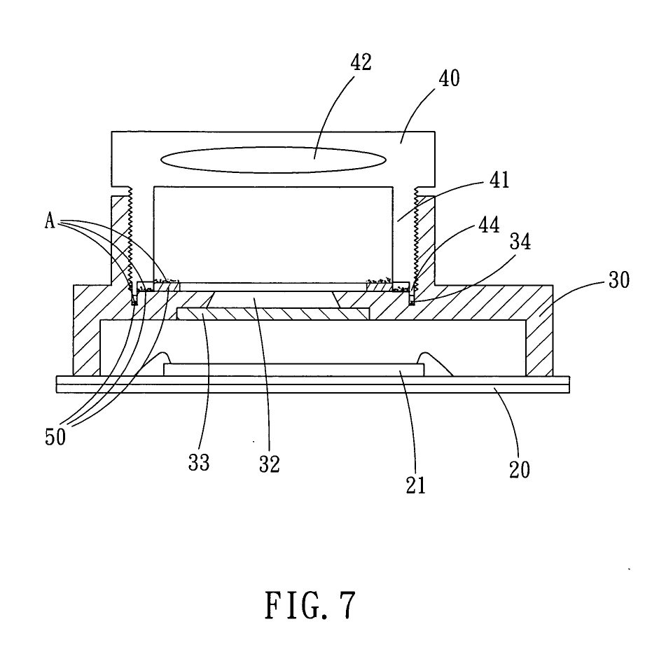

It will be noted that, in the second embodiment, the annular flange 44 of the lens tube 40 is located close to the inner periphery 43 of the end surface of the annular engaging portion 41, as shown in FIG. 4, and it also can be arranged in the center of the end surface of the annular engaging portion 41 of the lens tube 40, or can be located close to the outer periphery of the end surface of the annular engaging portion 41 of the lens tube 40, as shown in FIGS. 6 and 7.

While we have shown and described various embodiments in accordance with the present invention, it should be clear to those skilled in the art that further embodiments may be made without departing from the scope of the present invention.

What is claimed is:

1. An assembling structure for a solid image pickup device comprising:
a mounting base having an engaging recess, on an inner periphery of the engaging recess being formed a thread structure;
a lens tube having an annular engaging portion, on an outer periphery of the annular engaging portion being formed a thread structure, the annular engaging portion of the lens tube screwed in the engaging recess of the mounting base; and
at least an adhesive material arranged on a predetermined portion of a bottom surface of the engaging recess of the mounting base;
wherein the adhesive material is used to stick powder produced when screwing the lens tube with respect to the mounting base.

2. The assembling structure for a solid image pickup device as claimed in claim 1, wherein an annular groove is formed in the bottom surface of the engaging recess of the mounting base, on a terminal end of the annular engaging portion of the lens tube is formed an annular flange, the annular engaging portion of the lens tube is screwed in the engaging recess of the mounting base in such a manner that the annular flange of the lens tube is engaged in the annular groove of the mounting base.

3. The assembling structure for a solid image pickup device as claimed in claim 1, wherein the adhesive material is arranged on the bottom surface of the engaging recess of the mounting base and located beside an inner periphery of the annular engaging portion of the lens tube.

4. The assembling structure for a solid image pickup device as claimed in claim 1, wherein the adhesive material is double stick tape.

5. The assembling structure for a solid image pickup device as claimed in claim 1, wherein the adhesive material is glue.

6. The assembling structure for a solid image pickup device as claimed in claim 2, wherein the annular flange of the lens tube is located close to the inner periphery of an end surface of the annular engaging portion.

7. The assembling structure for a solid image pickup device as claimed in claim 2, wherein the annular flange of the lens tube is located at a center of an end surface of the annular engaging portion.

8. The assembling structure for a solid image pickup device as claimed in claim 2, wherein the annular flange of the lens tube is located close to an outer periphery of an end surface of the annular engaging portion.
